(19) United States
(12) Patent Application Publication
(10) Pub. No.: US 2009/0302588 A1
(43) Pub. Date: Dec. 10, 2009

(54) SYSTEMS AND METHODS FOR AIRBAG TETHER RELEASE

(75) Inventor: MICHAEL R. SCHRAMM, Perry, UT (US)

Correspondence Address: AUTOLIV ASP INC, 3350 AIRPORT ROAD, OGDEN, UT, 84405, US

(73) Assignee: AUTOLIV ASP, INC., Ogden, UT (US)

(21) Appl. No.: 12/134,021

(22) Filed: Jun. 5, 2008

(51) Int. Cl. B60R 21/16

(52) U.S. Cl. 280/743.2

(57) ABSTRACT

An inflatable airbag cushion assembly with a tether release device. The cushion assumes two different configurations depending on whether one or more tethers are released. The release device is actuated by one or more shape memory materials.

### TECHNICAL FIELD

The present disclosure relates generally to the field of automotive protective systems. More specifically, the present disclosure relates to release mechanisms for tethers connected with airbag cushions.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the disclosure's scope, the embodiments will be described and explained with specificity and detail in reference to the accompanying drawings in which:

FIG. 1A is a side elevation view of a vehicle, wherein a deployed airbag is restrained by a tether;

FIG. 1B is a side elevation view of the vehicle of FIG. 1A, wherein the deployed airbag is not restrained by a tether;

FIG. 2 is a perspective view of one embodiment of an airbag tether release mechanism;

FIG. 3A is a cross sectional view of the embodiment depicted in FIG. 2;

FIG. 3B is a cross sectional view of the embodiment depicted in FIGS. 2 and 3A shown after the cutter has cut through and released the tether;

FIG. 4A is a perspective view of a second embodiment of an airbag tether release mechanism;

FIG. 4B is a perspective view of the embodiment shown in FIG. 4A after the opening in the piston has been partially misaligned with the opening in the housing;

FIG. 4C is a perspective view of the embodiment shown in FIGS. 4A and 4B after the opening in the piston has been fully misaligned with the opening in the housing;

FIG. 5A is a perspective view of another embodiment of an airbag tether release mechanism;

FIG. 5B is a perspective view of the embodiment shown in FIG. 5A after the opening in the piston has been fully misaligned with the opening in the housing;

FIG. 6A is a perspective view of another embodiment of an airbag tether release mechanism;

FIG. 6B is a perspective view of the embodiment shown in FIG. 6A after the cutter has cut through a clip to release the tether;

FIG. 7A is a perspective view of another embodiment of an airbag tether release mechanism;

FIG. 7B is a top plan view of the embodiment depicted in FIG. 7A;

FIG. 7C is a side elevation view of the embodiment depicted in FIG. 7A and FIG. 7B;

FIG. 8A is a cross sectional view taken along line 8A-8A in FIG. 7A prior to deployment of the actuator;

FIG. 8B is a cross sectional view like that of FIG. 8A but taken after deployment of the actuator;

FIG. 9A is a perspective view of an embodiment of an airbag inflation module with a tether release mechanism;

FIG. 9B is a perspective view of the embodiment depicted in FIG. 9A following deployment of the inflator and release of the tether;

FIG. 10 is a perspective view of another embodiment of an airbag inflation module with a tether release mechanism;

FIG. 11 is a perspective view of a portion of still another embodiment of an airbag inflation module with a tether release mechanism;

FIG. 12A is a perspective view of the embodiment of FIG. 11 with the tether captured; and,

FIG. 12B is a perspective view of the embodiment of FIG. 12A with the tether released.

### INDEX OF ELEMENTS IDENTIFIED IN THE DRAWINGS

10 airbag
50 tether
55 end of tether
100 tether release mechanism
105 actuator
106 shape memory material
110 housing
115 opening
120 cutter
121 cutting blade
122 cutter slot
200 tether release mechanism
205 actuator
206 shape memory material
210 housing
215 opening
220 piston
225 opening
300 tether release mechanism
305 actuator
306 shape memory material
310 housing
315 tether restraint structure
316 recess
317 prongs
318 end of clip
320 cutter
322 cutter slot
325 opening
400 tether release mechanism
405 actuator
406 shape memory material
410 housing
415 opening
419 pin
420 piston
421 cutting blade
422 slot
425 opening
500 tether release mechanism
505 actuator
506 shape memory material
510 housing
515 opening
519 pin
520 piston
521 cutting blade
522 slot
525 opening
600 airbag module
670 tether release mechanism
606 shape memory alloy
607 wires
640 housing
650 first inflator
655 gas exit ports
660 second inflator
665 gas exit ports
670 tether release mechanism
671 anchor
676 pin
680 capture component
700 airbag module
770 tether release mechanism
706 shape memory alloy
740 housing
750 first inflator
760 second inflator
770 tether release mechanism
774 hinge
776 pin
780 capture member
800 airbag module
806 shape memory alloy
840 housing
850 first inflator
860 second inflator
870 tether release mechanism
871 anchor
872 first end
873 rod
874 second end
880 capture member
881 base
882 rocker
883 apertures
884 flanges
885 plate member
888 arm
889 clip

### DETAILED DESCRIPTION OF PREFERRED EMBODIMENTS

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abutting” refers to items that are in direct physical contact with each other, although the items may not necessarily be attached together.

Inflatable airbag systems are widely used to minimize occupant injury in a collision scenario. Airbag modules have been installed at various locations within a vehicle, including, but not limited to, the steering wheel, the instrument panel, within the side doors or side seats, adjacent to roof rail of the vehicle, in an overhead position, or at the knee or leg position. In the following disclosure, “airbag” may refer to an inflatable curtain airbag, overhead airbag, front airbag, or any other airbag type.

Front airbags are typically installed in the steering wheel and instrument panel of a vehicle. During installation, the airbags are rolled, folded, or both, and are retained in the rolled/folded state behind a cover. During a collision event, vehicle sensors trigger the activation of an inflator, which rapidly fills the airbag with inflation gas. Thus the airbag rapidly changes confirmations from the rolled/folded configuration to an expanded configuration.

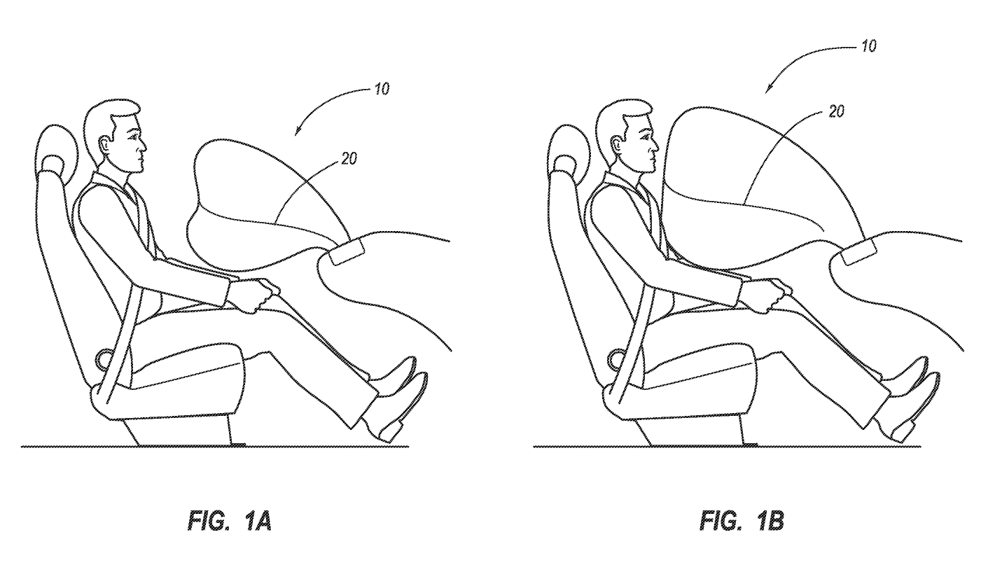

FIG. 1A depicts partial deployment of an airbag 10 with an internal tether 50. Tether 50 is shown in FIG. 1A restraining airbag 10 and restricting its inflation size. FIG. 1B depicts tether 50 after it has been released to allow airbag 10 to be fully inflated. As will become apparent, the depiction of FIG. 1B is achieved after activation of a tether release mechanism allowed tether 50 to be released from one of its internal connections with airbag 10 and thereby allow airbag 10 to fully inflate.

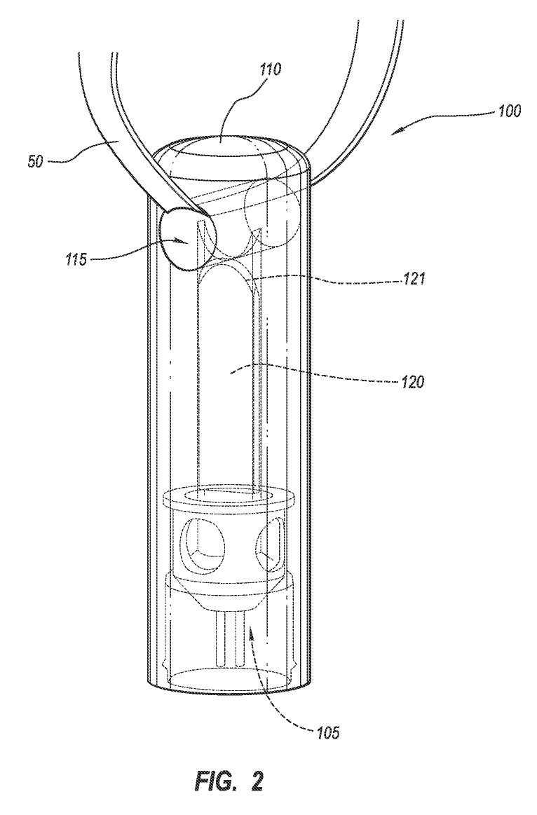

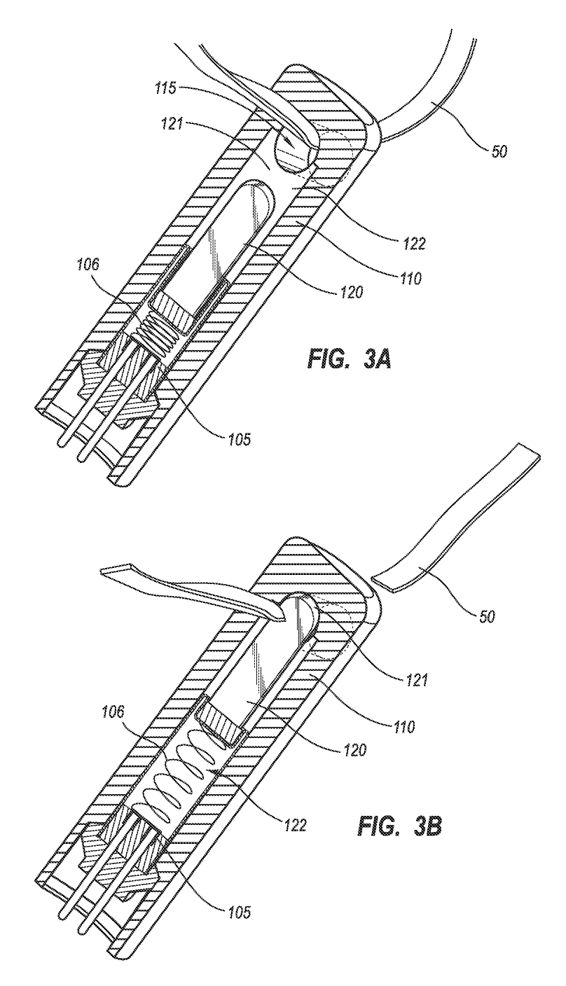

FIGS. 2 and 3A-3B, depict a tether release mechanism 100. Tether release mechanism 100 may comprise a housing 110, an actuator 105, and a tether cutter 120. Actuators disclosed herein may comprise one or more active materials, including shape memory materials (SMM), which act as an actuator to directly or indirectly allow the release of a tether. Actuators disclosed herein may be activated in conjunction with one or more inflators such that the tether release mechanism is operatively coupled to the inflator, or alternatively the actuator may be activated independently and may function independently of the inflator.

The term “active material” as used herein generally refers to a material that exhibits a change in a property such as dimension, shape, shear force, or flexural modulus upon application of an activation signal. Suitable active materials include, without limitation, shape memory alloys (SMA), ferromagnetic SMAs, shape memory polymers (SMP), piezoelectric materials, electroactive polymers (EAP), magnetorheological fluids and elastomers (MR), and electrorheological fluids (ER). Depending on the particular active material, the activation signal can take the form of, without limitation, an electric current, a temperature change, a magnetic field, a mechanical loading or stressing, or the like.

Actuator 105 may be configured such that it is non-flashing and non-propulsive. In other words, actuator 105 does not emit a flash and has no loose parts (parts that leave the device other than a tether or similar released articles—e.g., a bolt). Thus, an o-ring need not be used in order to seal the actuator in the housing and prevent propulsion and flashing. This may also be useful because it may allow the device to be classified in a less restrictive hazard category. The SMM of actuator 105 may be activated electrically via wires depicted in FIG. 2, or by heating or cooling the SMM.

Tether release mechanism 100 may be mounted on the back of an inflator module. Tether 50 in FIG. 2 extends through an opening 115 formed within the housing 110. A cutter 120 having a cutting blade 121 is operatively connected with the actuator 105. This allows deployment of actuator 105 to actuate the cutter 120, as described below.

FIGS. 3A-3B are cross sectional views of tether release mechanism 100, in which SMM 106 is configured as a coil of a Shape Memory Alloy (SMA). SMA 106 is in a compact configuration in FIG. 3A and upon receiving an activating signal at least partially changes configuration to a more extended shape, as in FIG. 3B.

Cutter 120 is slideable within a cutter slot 122 formed in housing 110. Cutter 120 is configured and positioned such that it may be moved from a position adjacent to opening 115, as shown in FIG. 3A, to a position at which it is at least partially coincident with opening 115, as shown in FIG. 3B. Once actuator 105 has been activated, cutter 120 is actuated or moved axially within housing 110 such that it extends into opening 115, thereby allowing cutting blade 121 to cut through tether 50. Opening 115 in the embodiment depicted in FIGS. 2 and 3A-3B comprises a tether restraint structure configured to secure tether 50 until it is released by actuation of cutter 120.

Cutter 120 may be positioned within cutter slot 122 such that it is only slideable after a threshold amount of force has been applied to cutter 120. For example, cutter 120 may be tightly positioned within cutter slot 122 such that a threshold amount of friction must be overcome before cutter 120 can be slid up to opening 115. In this manner, unintentional repositioning of cutter 120 can be prevented or at least minimized. It may be desirable in some embodiments to configure the device such that a level of force just under that provided by the actuator is required to move cutter 120.

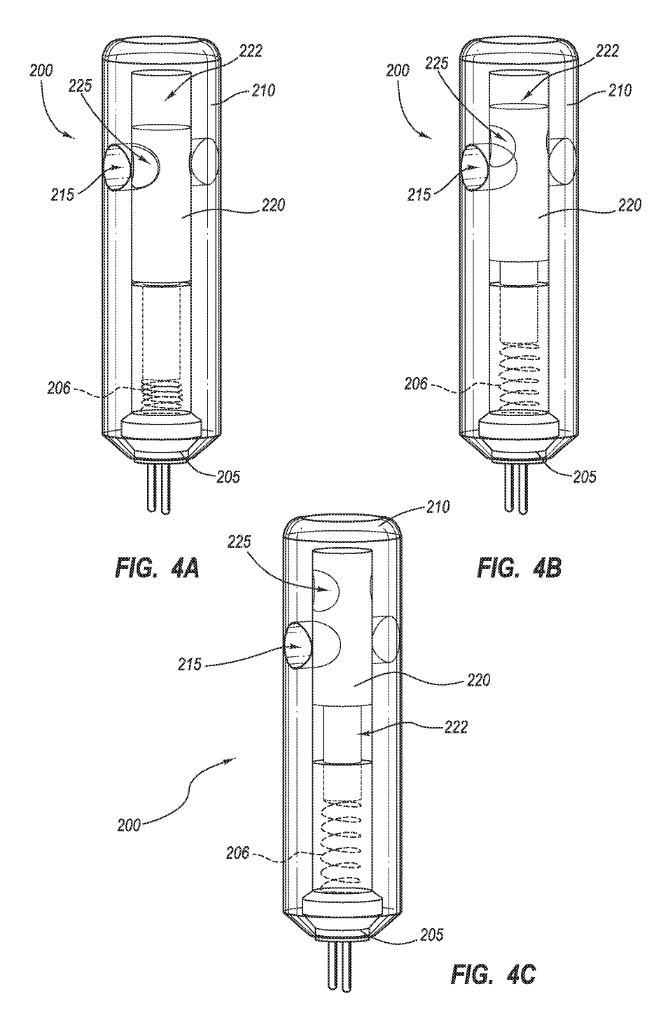

A second embodiment is shown in FIGS. 4A-4C. Tether release mechanism 200 includes an actuator 205 positioned within a housing 210. Like actuator 105 in the embodiment shown in the previous figures, actuator 205 may comprises a SMA coil 206 that is initially in a compact or more coiled configuration, and upon activation becomes more extended. The extension of the SMA coil is configured to allow a tether to be released.

Housing 210 again has an opening 215 formed therein and extending from one side of housing 210 to the other and serving as a tether restraint structure configured to secure a tether until the tether is released by actuation of a cutter 220. Cutter 220 in this embodiment does not comprise a cutting blade. Instead, cutter 220 comprises a piston having an opening 225 formed therein. Piston 220 is positioned in a cylindrical slot 222 within housing 210 and is configured to be slideable within slot 222. Piston 220 may be frictionally engaged within the portion of housing 210 which defines slot 222 such that a threshold level of force is required to slide piston 220 within slot 222. Piston 220 is configured such that, prior to deployment of the actuator 205, the opening 215 in the housing 210 is aligned with the opening 225 in the piston 220, and wherein, following deployment of the actuator 205, the opening 225 in the piston 220 is moved out of alignment with the opening 215 in the housing 210.

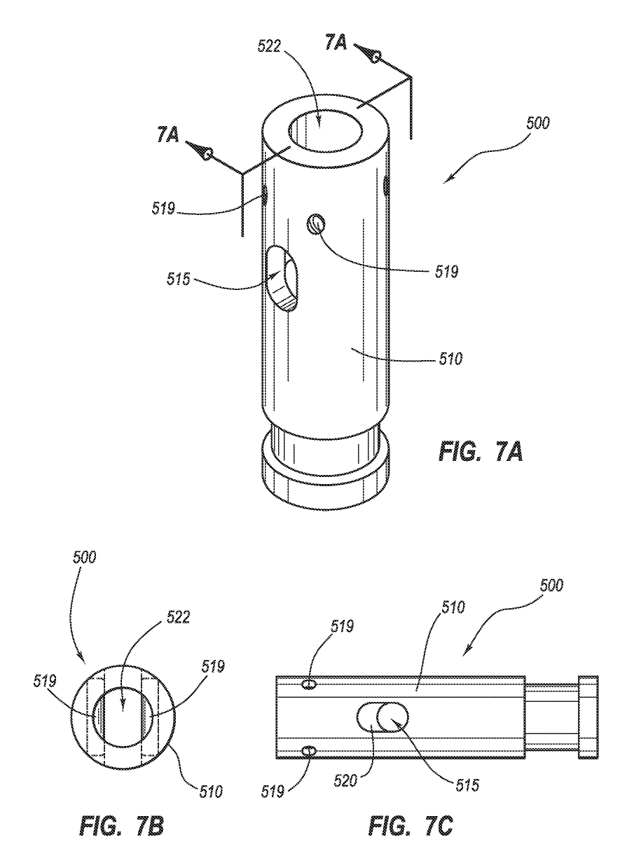

A tether (not shown) may be strung through the aligned openings 215 and 225. Upon deployment of actuator 205, the force on piston 220 causes the misalignment of the two openings. The shearing force from the sliding of piston 220 within slot 222 may be used to sever the tether. Of course, many alternatives are possible. For example, the portion of piston 220 that defines opening 225 may be sharpened to further facilitate cutting the tether. A cutting blade may also be provided to cut the tether if desired. As yet another alternative, in some embodiments it may be desirable to provide an opening in the housing that is sized differently on opposing sides of the housing. This may allow for a tether to be cut on one side of the opening only (the side where the edge of the opening in the housing and the edge of the opening in the piston come into contact first). An example of such a feature can be seen in the embodiment of FIGS. 7A and 7C.

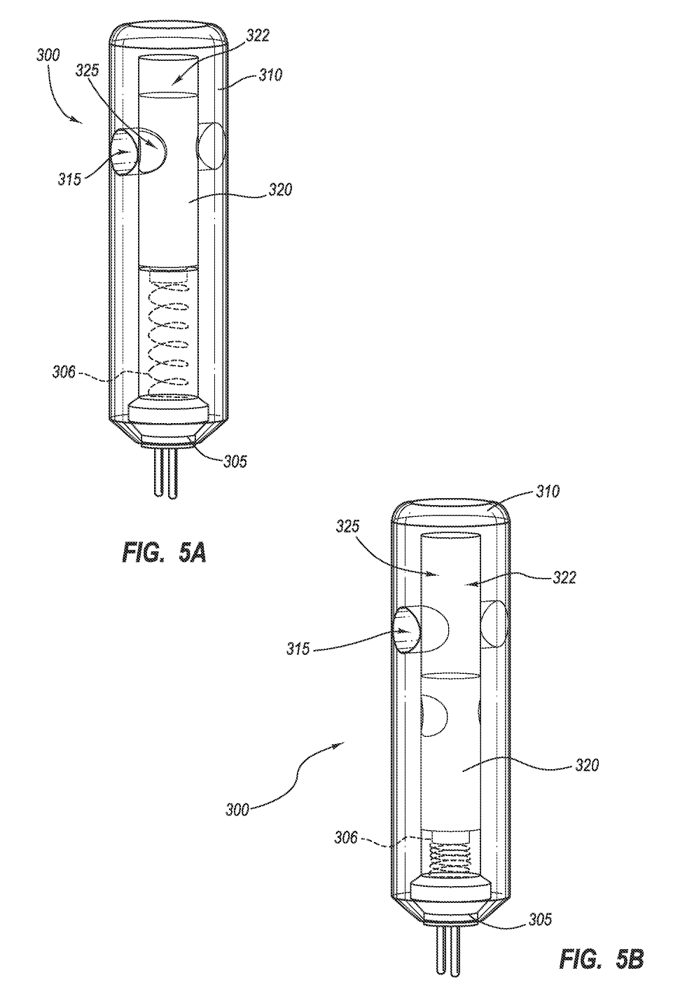

FIGS. 5A and 5B depict another embodiment of a tether release mechanism 300 with a housing 310. Release mechanism 300 may be configured similarly and may function similarly as release mechanism 200, except where the following description of mechanism 300 differs from that of mechanism 200. Actuator 305 and SMM 306 are configured to operate in a manner that is opposite to release mechanism 200. In the depicted embodiment, SMM 306 is coupled to piston 320 and comprises a piece of SMA that is initially in an extended configuration (FIG. 5A) and after activation changes configuration to a more compact state. As a result, piston 325 is pulled down within shaft 322 and openings 315 and 325 become at least partially misaligned.

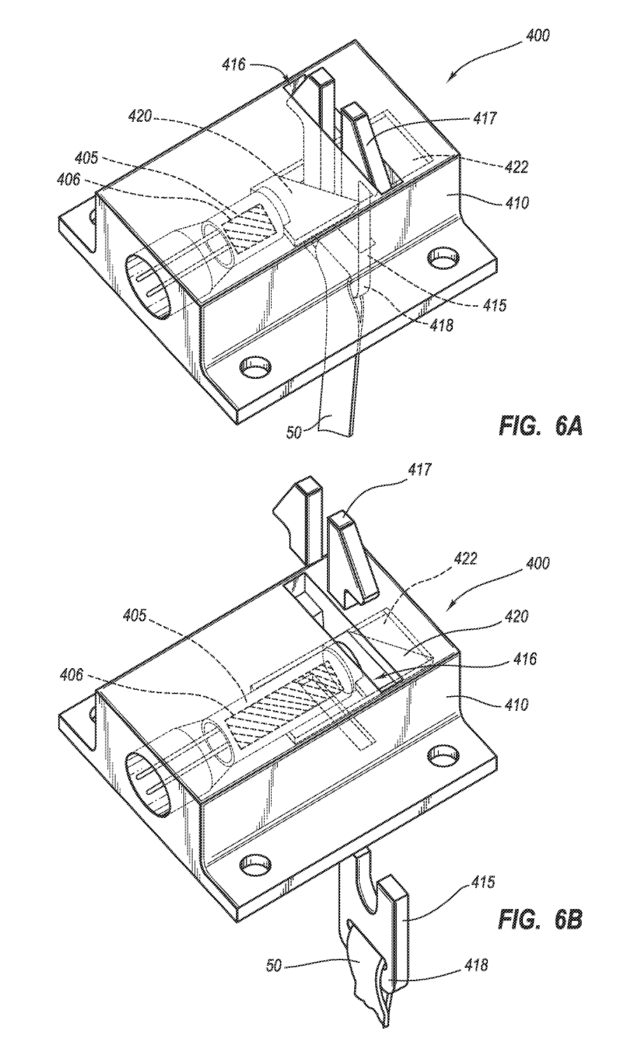

Still another embodiment is depicted in FIGS. 6A-6B. Tether release mechanism 400 again includes an actuator 405 positioned within a housing 410. Actuator 405 may comprise a SMM, such as a Shape Memory Polymer (SMP), wherein the SMP is configured to expand upon receiving an activation signal. Actuator 405 is non-flashing and non-propulsive such that it does not emit a flash and has no loose parts that it propels upon deployment. Actuator 405 may also be provided with an inherent seal. Tether release mechanism 400 includes a tether restraint structure 415. Tether restraint structure 415 in this embodiment comprises a clip. Clip 415 is configured to snap into a recess 416 formed within the housing 410. Clip 415 has two prongs 417 that may be somewhat flexible to allow them to bend and snap into place within recess 416. It should be understood, however, that embodiments are contemplated which include only a single prong. Clip 415 is also configured to secure a tether 50. In this embodiment, tether 50 is looped around an opening at end 418 of clip 415.

Clip 415 is configured to secure tether 50 until the tether 50 is released by actuation of a cutter 420. Cutter 420 is positioned adjacent to actuator 405 so that the deployment force from actuator 405 can be translated to cutter 420. Cutter 420 is slideable within slot 422, which is formed within housing 410. Upon deployment of the actuator 405, cutter 420 is configured to sever the prongs 417 of clip 415, thereby releasing tether 50, as shown in FIG. 6B.

Any of the embodiments described above can be used to restrain a tether, deploy an actuator that actuates a cutter, and release the tether by actuating the cutter. The tether may be restrained by an opening in the housing, as in the embodiments shown in FIGS. 2-5C, by a clip, as in the embodiment shown in FIGS. 6A-6B, or by any other similar structures that this disclosure would suggest to, or otherwise available to, a person having ordinary skill in the art. Each of the foregoing are examples of restraining means for restraining an airbag tether.

The tether may be released with a cutting blade, by a piston having an opening formed therein so as to provide a shearing force, or by any other similar structures that this disclosure would suggest to, or otherwise available to, a person having ordinary skill in the art. Each of the foregoing are examples of releasing means for releasing the tether from the restraining means. The tether may be released by directly cutting the tether. The tether may alternatively be released by cutting a tether restraint structure restraining the tether.

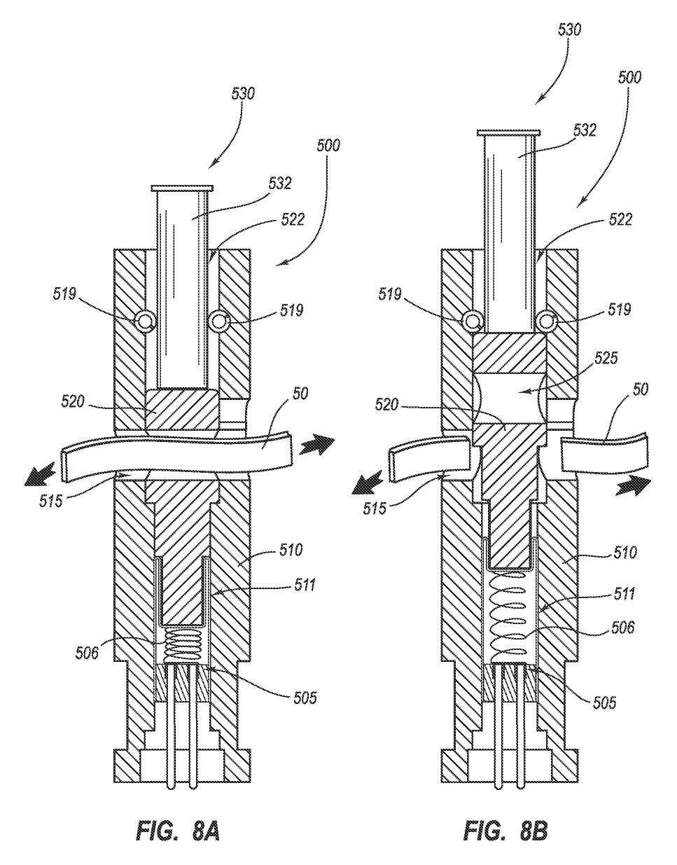

Yet another embodiment is depicted in FIGS. 7A-8B. Tether release mechanism 500 includes an actuator 505 positioned within a housing 510. Actuator 505 may comprise a coil of a shape memory alloy 506 such that the actuator is non-flashing and non-propulsive. Actuator 505 may also be provided with an inherent seal.

Tether release mechanism 500 also includes a tether restraint structure 515, which in this embodiment comprises an opening 515 formed within housing 510. Tether release mechanism 500 further includes a pin structure 519, which in this embodiment comprises a split spring pin 519. The function of split spring pin 519 will be discussed in greater detail below.

As shown in the cross sectional views of FIGS. 8A and 8B, tether release mechanism also includes a cutter 520, which comprises a piston having an opening 525 formed therein. Piston 520 is positioned in a cylindrical slot 522 within housing 510 and is configured to be slideable within slot 522. One end of piston 520 is positioned adjacent to actuator 505. Actuator 505 may comprise an SMA 506, which is initially in a compact configuration, and upon receiving an activation signal, changes configuration to a more extended state.

Like some embodiments previously discussed, piston 520 is configured such that, prior to deployment of the actuator 505, the opening 515 in the housing 510 is aligned with the opening 525 in the piston 520, and wherein, following deployment of the actuator 505, the opening 525 in the piston 520 is moved out of alignment with the opening 515 in the housing 510. A tether 50 may therefore be strung through the aligned openings 515 and 525. Upon deployment of actuator 505, the force on piston 520 causes the misalignment of the two openings. The shearing force from the sliding of piston 520 within slot 522 may be used to sever the tether 50.

Unlike any of the previously disclosed embodiments, tether release mechanism 500 also includes an actuator 530, which may be coupled to another structure such that the actuator is operably coupled the other structure. For example, the other structure may comprise a closeable or openable dynamic vent, such that activation of the tether release mechanism operates a dynamic vent. Actuator 530 includes a connecting rod 532. Connecting rod 532 is attached to piston 520 at the distal end (relative to actuator 505) of piston 520. Split spring pin 519 prevents piston 520 from exiting the housing 510. Connecting rod 532, on the other hand, is capable of passing by the split spring pin 519 due to its smaller diameter such that it can, at least partially, exit the housing 510.

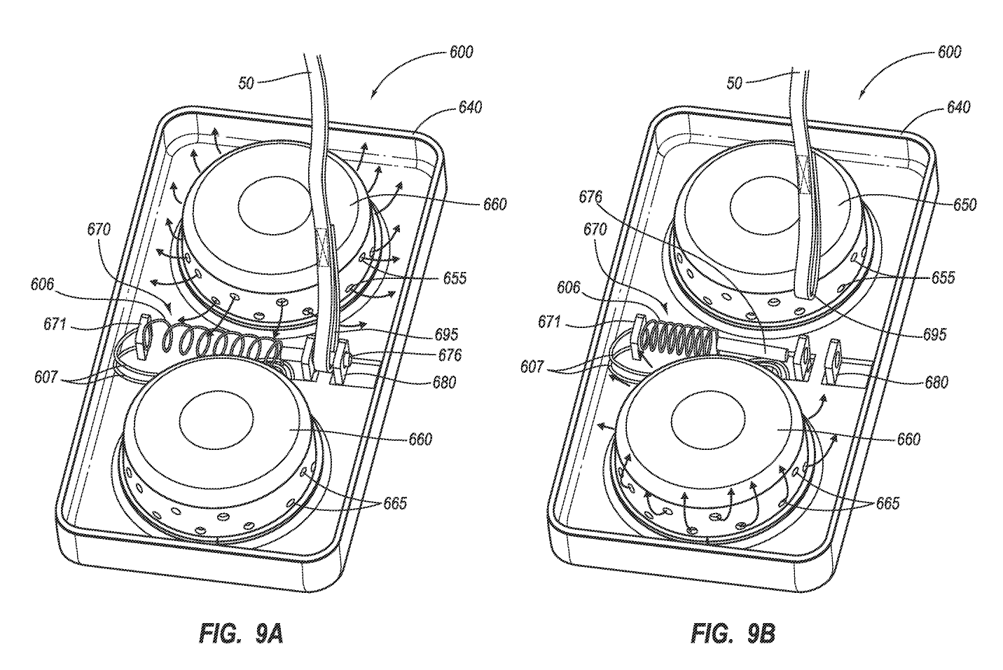

FIGS. 9A-9B depict another embodiment of a tether release mechanism that is coupled to an inflation module. Inflation module 600 includes module housing 640, first inflator 650, and second inflator 660. First inflator 650 includes exit gas ports 655 and second inflator 660 includes exit gas ports 665. Module housing 640 is an example of means for housing an airbag inflation module. First inflator 650 and second inflator 660 are examples of inflation means for inflating an inflatable cushion. It should be understood that the terms “first” and “second” are used arbitrarily and for the sake of convenience in labeling only. These terms should not be interpreted so as to require or imply a particular sequence in the deployment of the inflators. First inflator 650 can be deployed before, simultaneously with, or after second inflator 660 depending upon, for example, the airbag system used, the circumstances and characteristics of the crash, and the desired shape and size of the airbag cushion.

Tether release mechanism 670 may comprise an actuator 605, a pin 676, and a capture component 680. Actuator 605 may comprise a SMM, such as a coil of SMA 606, as depicted in FIG. 9A. On one end, SMA 606 is coupled to housing 640 at an anchor 671 and at another end, the SMA is coupled to (or defines) pin 676.

Tether release mechanism 670 is adapted to have a first configuration wherein the tether release mechanism holds a tether and a second configuration wherein the tether is released from Tether release mechanism 670. This allows an airbag system incorporating this embodiment to deploy variably, both with respect to the volume and/or shape of the airbag cushion. Maintaining the tether release mechanism in its first configuration allows the tether to restrain the size and/or shape of the airbag upon deployment, whereas reconfiguring the tether release mechanism such that it is in the second configuration allows the airbag cushion to fully inflate. Of course, more than one tether and/or more than one tether release mechanism may be used to customize deployment characteristics as desired for any number of applications.

In the embodiment shown in FIGS. 9A-9B, tether release mechanism 670 comprises a pin. In such embodiments in which the tether release mechanism comprises a pin, the pin may be metal, rubber, strapping, fabric, such as braided nylon, or any other structure or material available to one of skill in the art. SMA 606 may be attached to pin 676 or, alternatively, it may integrally form pin 676. Likewise, pin 676 may be comprised of the same material as SMA 606 or of a different material.

Pin 676 is adapted to hold a tether 50 connected with an inflatable cushion (not shown), as can be seen from the figures. Tether 50 is an example of means for restraining the inflation size of an inflatable cushion. Pin 676 is an example of means for holding the restraining means in a position in which it restricts the inflation size of an inflatable cushion. Tether 50 is looped at one end 55 and the tether loop 55 is connected with pin 676, which is held by capture component 680.

Pin 676 fits within capture component 680 in the first configuration of tether release mechanism 670 and is removed from capture component 680 in the second configuration of tether release mechanism 670. Once pin 676 has been pulled from capture component 680, tether loop 55 is no longer looped around pin 676 and tether 50 no longer restricts the inflation size of the airbag cushion (not shown), as depicted in FIG. 9B.

Tether release mechanism or pin 676 is adapted to release tether 50 upon receiving an activation signal. As described herein, the activation signal may be delivered via wires 607 and causes a change in conformation in SMA 606, which may comprise a portion of tether release mechanism 670. The activation signal may or may not also activate one or more of the inflators. SMA 606 changing conformation from an extended state to a less extended state causes pin 676 to be withdrawn from capture component 680. As will be appreciated by one skilled in the art, in an alternative embodiment, the pin, the tether release mechanism, and the actuator may all comprise a single piece of a SMA.

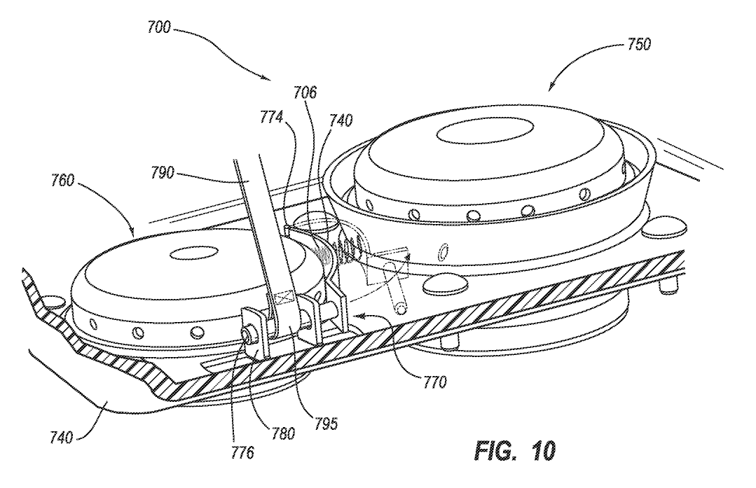

Another embodiment is shown in FIG. 10. FIG. 10 depicts an inflation module 700 including first inflator 750 and second inflator 760, both of which are positioned in module housing 740. Inflation module 700 includes a tether release mechanism 770. Tether release mechanism 770 is rigid and includes hinged region 774. Opposite from hinged region 774 is a pin 776, which is configured to fit within capture member 780. Tether 50 is looped around pin 776 at a tether end 55 to form tether loop 55.

As with tether release mechanism 670, the tether release mechanism 770 comprises a SMM that changes configuration to cause a pin to be withdrawn, thereby releasing a tether. Activation of SMA may be achieved, for example, via an electrical current through wires, which results in coil 706 results changing conformations from a compact configuration to a more extended state. Upon activation SMA 706 pushes on tether release mechanism 770, causing it to pivot at hinged region 774 and pull pin 776 from capture member 780, thereby releasing tether 50 and allowing the airbag (not shown) to fully inflate. Tether release mechanism 770 is shown pivoted away from second inflator 760 in phantom in FIG. 10.

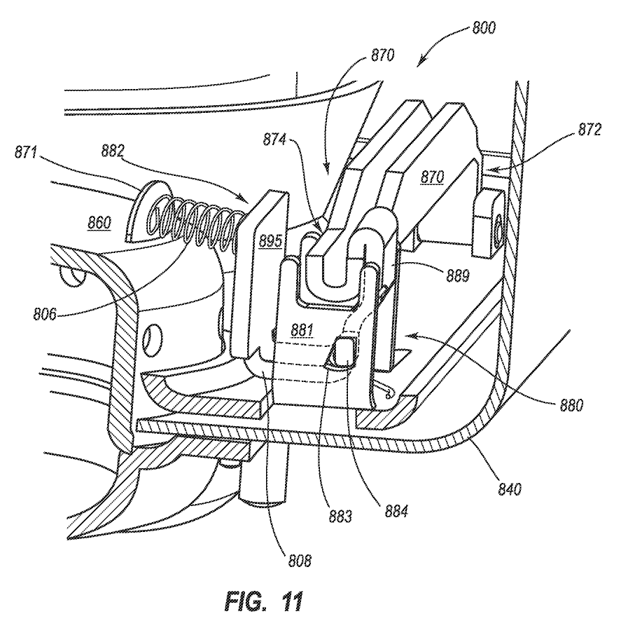

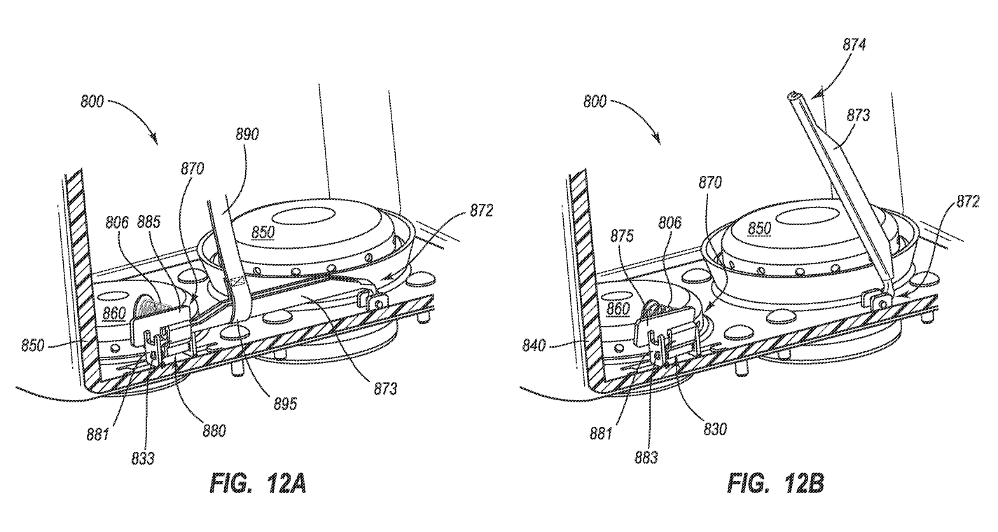

Still another embodiment is shown in FIGS. 11 and 12A-12B. In these figures, an inflation module 800 is depicted. Inflation module 800 includes housing 840 and a tether release mechanism 870. Housing 840 holds first inflator 850 and second inflator 860. Tether release mechanism 870 comprises an actuator 805 that includes a SMM, such as a SMA coil 806. Tether release mechanism 873 comprises a rod 873. Rod 873 may be pivotally coupled at a first end 872 to a bracket attached to housing 840. Rod 873 may be configured to pivot vertically, as shown, or in any other manner, such as horizontally.

A capture component 880, which is connected with housing 840, includes a capture base 881 and a capture rocker 882. Capture base 881 may include a pair of opposing apertures 883, which are adapted to receive a pair of opposing flanges 884, one of which may be seen in FIG. 11. Flanges 884 extend from capture rocker 882. Apertures 883 are adapted to allow flanges 884 to pivot therein, such that capture rocker 882 can pivot about flanges 884. Capture rocker 882 also includes a plate member 885. Plate member 885 is disposed adjacent to inflator 860 and is connected with arm 888, as shown in FIG. 11. Arm 888, which extends from plate member 885, extends to a clip member 889.

The second end 874 of rod 873 may rest on or partially nest within capture base 881. Clip member 889 engages second end 874 of rod 873 and retains rod 873 in a fixed position for tether retention. As shown in FIGS. 12A-12B, tether 50 is held by tether release mechanism 870 at an end 55 of the tether. Capture component 880 secures rod 873 in a fixed position and retains tether 50.

Plate member 885 is configured to receive pressure from actuator 805 when SMA coil 806 changes configurations from compact to more extended. Sufficient pressure from SMA coil 806 on plate 885 causes capture rocker 882 to rock or pivot sufficient to disengage clip member 889 from its position of retention against rod 873. Rod 873 is thereby disengaged at its second end 874 and pivots freely about its first end 872, as shown in FIG. 12B. As the airbag cushion expands, tether 50 is tightened and is readily pulled off of rod 873. The airbag cushion is then able to expand to its full capacity.

Suitable shape memory alloys can exhibit a one-way shape memory effect, an intrinsic two-way effect, or an extrinsic two-way shape memory effect depending on the alloy composition and processing history. The two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic shape memory effect are fabricated from a shape memory alloy composition that will automatically reform themselves.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like. For example, a nickel-titanium based alloy is commercially available under the trademark NITINOL from Shape Memory Applications, Inc.

Other suitable active materials are shape memory polymers. Similar to the behavior of a shape memory alloy, when the temperature is raised through its transition temperature, the shape memory polymer also undergoes a change in shape orientation. Dissimilar to SMAs, raising the temperature through the transition temperature causes a substantial drop in modulus. While SMAs are well suited as actuators, SMPs are better suited as “reverse” actuators. That is, by undergoing a large drop in modulus by heating the SMP past the transition temperature, release of stored energy blocked by the SMP in its low temperature high modulus form can occur. To set the permanent shape of the shape memory polymer, the polymer must be at about or above the Tg or melting point of the hard segment of the polymer. “Segment” refers to a block or sequence of polymer forming part of the shape memory polymer. The shape memory polymers are shaped at the temperature with an applied force followed by cooling to set the permanent shape. The temperature necessary to set the permanent shape is preferably between about 100° C. to about 300° C. Setting the temporary shape of the shape memory polymer requires the shape memory polymer material to be brought to a temperature at or above the Tg or transition temperature of the soft segment, but below the Tg or melting point of the hard segment. At the soft segment transition temperature (also termed “first transition temperature”), the temporary shape of the shape memory polymer is set followed by cooling of the shape memory polymer to lock in the temporary shape. The temporary shape is maintained as long as it remains below the soft segment transition temperature. The permanent shape is regained when the shape memory polymer fibers are once again brought to or above the transition temperature of the soft segment. Repeating the heating, shaping, and cooling steps can reset the temporary shape. The soft segment transition temperature can be chosen for a particular application by modifying the structure and composition of the polymer. Transition temperatures of the soft segment range from about −63° C. to above about 120° C.

Shape memory polymers may contain more than two transition temperatures. A shape memory polymer composition comprising a hard segment and two soft segments can have three transition temperatures: the highest transition temperature for the hard segment and a transition temperature for each soft segment.

Most shape memory polymers exhibit a “one-way” effect, wherein the shape memory polymer exhibits one permanent shape. Upon heating the shape memory polymer above the first transition temperature, the permanent shape is achieved and the shape will not revert back to the temporary shape without the use of outside forces. As an alternative, some shape memory polymer compositions can be prepared to exhibit a “two-way” effect. These systems consist of at least two polymer components. For example, one component could be a first cross-linked polymer while the other component is a different cross-linked polymer. The components are combined by layer techniques, or are interpenetrating networks, wherein two components are cross-linked but not to each other. By changing the temperature, the shape memory polymer changes its shape in the direction of the first permanent shape of the second permanent shape. Each of the permanent shapes belongs to one component of the shape memory polymer. The two permanent shapes are always in equilibrium between both shapes. The temperature dependence of the shape is caused by the fact that the mechanical properties of one component (“component A”) are almost independent from the temperature in the temperature interval of interest. The mechanical properties of the other component (“component B”) depend on the temperature. In one embodiment, component B becomes stronger at low temperatures compared to component A, while component A is stronger at high temperatures and determines the actual shape. A two-way memory device can be prepared by setting the permanent shape of component A (“first permanent shape”); deforming the device into the permanent shape of component B (“second permanent shape”) and fixing the permanent shape of component B while applying a stress to the component.

Similar to the shape memory alloy materials, the shape memory polymers can be configured in many different forms and shapes. The temperature needed for permanent shape recovery can be set at any temperature between about −63° C. and about 120° C. or above. Engineering the composition and structure of the polymer itself can allow for the choice of a particular temperature for a desired application. A preferred temperature for shape recovery is greater than or equal to about −30° C., more preferably greater than or equal to about 0° C., and most preferably a temperature greater than or equal to about 50° C. Also, a preferred temperature for shape recovery is less than or equal to about 120° C., more preferably less than or equal to about 90° C., and most preferably less than or equal to about 70° C.

Suitable shape memory polymers include thermoplastics, thermosets, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymers, polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, and the like.

The shape memory polymer or the shape memory alloy, may be activated by any suitable means, preferably a means for subjecting the material to a, temperature change above, or below, a transition temperature. For example, for elevated temperatures, heat may be supplied using hot gas (e.g., air), steam, hot liquid, or electrical current. The activation means may, for example, be in the form of heat conduction from a heated element in contact with the shape memory material, heat convection from a heated conduit in proximity to the thermally active shape memory material, a hot air blower or jet, microwave interaction, resistive heating, and the like. In the case of a temperature drop, heat may be extracted by using cold gas, or evaporation of a refrigerant. The activation means may, for example, be in the form of a cool room or enclosure, a cooling probe having a cooled tip, a control signal to a thermoelectric unit, a cold air blower or jet, or means for introducing a refrigerant (such as liquid nitrogen) to at least the vicinity of the shape memory material.

Furthermore, any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Without further elaboration, it is believed that one skilled in the art can use the preceding description to utilize the present disclosure to its fullest extent. The examples and embodiments disclosed herein are to be construed as merely illustrative and not a limitation to the scope of the present disclosure in any way. It will be apparent to those having skill in the art that changes may be made to the details of the above-described embodiments without departing from the underlying principles of the disclosure described herein. In other words, various modifications and improvements of the embodiments specifically disclosed in the description above are within the scope of the appended claims. Note that elements recited in means-plus-function format are intended to be construed in accordance with 35 U.S.C. § 112 ¶6. The scope of the disclosure is therefore defined by the following claims.

1. An airbag tether release mechanism, comprising:
a housing;
an actuator coupled to the housing and comprising one or more shape memory materials; and,
a tether release mechanism coupled to the actuator and configured to secure a tether until the tether is released by actuation of the actuator.

2. The airbag tether release mechanism of claim 1, wherein the one or more shape memory materials comprise a shape memory alloy.

3. The airbag tether release mechanism of claim 2, wherein the shape memory alloy is configured in a coil.

4. The airbag tether release mechanism of claim 1, wherein the shape memory material is initially in a compact configuration and upon being activated the shape memory material adopts a configuration that is more extended than the compact configuration.

5. The airbag tether release mechanism of claim 1, wherein the shape memory material is initially in an extended configuration and upon being activated the shape memory material adopts a configuration that is more compact than the extended configuration.

6. An airbag tether release mechanism, comprising:
a housing;
an actuator located within the housing and comprising one or more shape memory materials;
a cutter located within the housing; and,
a tether restraint structure configured to secure a tether until the tether is released by actuation of the cutter.

7. The airbag tether release mechanism of claim 6, wherein the one or more shape memory materials comprise a shape memory alloy.

8. The airbag tether release mechanism of claim 7, wherein the shape memory alloy is configured in a coil.

9. The airbag tether release mechanism of claim 6, wherein the shape memory material is initially in a compact configuration and upon being activated the shape memory material adopts a configuration that is more extended that the compact configuration.

10. The airbag tether release mechanism of claim 6, wherein the shape memory material is initially in an extended configuration and upon being activated the shape memory material adopts a configuration that is more compact than the extended configuration.

11. A method for releasing an airbag tether, comprising:
restraining a tether, wherein a first end of a tether is connected to an airbag cushion;
activating a shape memory material; and
releasing the tether, wherein the activation of the shape memory material causes the release of the tether.

12. The method of claim 11, wherein the shape memory material comprises a shape memory alloy.

13. The method of claim 11, wherein activation of the shape memory material causes the tether to be cut.

14. The method of claim 11, wherein activation of the shape memory material causes a pin to be retracted from a tether capture component.
